(19) United States
(12) Patent Application Publication
(10) Pub. No.: US 2006/0144609 A1
(43) Pub. Date: Jul. 6, 2006

(54) Discrete access point mounting system

(75) Inventor: Robert M. Hathaway, Ivoryton, CT (US)

Correspondence Address: MCCARTER & ENGLISH LLP;CITYPLACE I, 185 ASYLUM STREET, HARTFORD, CT, 06103, US

(73) Assignee: Ortronics, Inc., New London, CT (US)

(21) Appl. No.: 11/321,296

(22) Filed: Dec. 27, 2005

Related U.S. Application Data
(60) Provisional application No. 60/640,413, filed on Dec. 30, 2004.

(51) Int. Cl. H01H 13/04

(52) U.S. Cl. 174/58

(57) ABSTRACT

A discrete access point mounting system is provided that is configured to be mounted to a wall or other like mounting surface. The discrete access point mounting system provides for the consolidation of one or more receptacle connections behind a single mounting plate to enhance the functionality and aesthetic appearance of access points. Moreover, the system enhances the protection of cable from a connector jack to one or more receptacles from damage and contamination. The discrete access point mounting system includes a surface mounting plate suitable for being mounted or connected to a wall or other like mounting surface. The surface mounting plate defines a frame having at least one receptacle opening suitable for mounting at least one connector receptacle and further including at least one wall mounting feature. The wall mounting feature supports the weight of the discrete access point mounting system, the weight of an access point, or a combination thereof. A jack mounting plate is operatively connected to the surface mounting plate and defines a frame having a jack opening suitable for mounting at least one connector jack. The area between the surface mounting plate and the jack mounting plate defines a cord storage area suitable for storing a length of cord connecting a connector jack and at least one connector receptacle.

### CROSS REFERENCE TO RELATED APPLICATIONS

This patent application claims priority to U.S. Provisional Patent Application No. 60/640,413, filed Dec. 30, 2004, the entire disclosure of which is hereby incorporated by reference.

### FIELD OF THE INVENTION

The present invention relates generally to access point management equipment. More particularly, the present invention relates to connecting assemblies such as access point outlets for accommodating adapters/receptacles and the like suitable for connecting various electrical and cable communication lines. Still more particularly, the present disclosure relates to a discrete access point mounting system for network and power connection lines.

### BACKGROUND OF THE INVENTION

Effective cable management is extremely important in industries like the telecommunication industry where effective cable management can enhance signal transmission quality, protect connection regions from impact related damage, and prevent contamination. Access points are used for connecting devices, for example computers, telephones, fax machines, etc., to network connections via RF technologies. Access points for network connectivity and power connectivity are typically not discrete. Access points may be wall mounted, floor mounted, or desk/table mounted, and are typically not aesthetically pleasing in appearance.

Despite efforts to date, a need remains for improved access point mounting systems that more effectively conceal multiple connections behind a single mounting plate. In particular, there is a need for an access point mounting system where a number of receptacles, cables, wires or other sources are managed within a single discrete system. In addition, there is a need for access point mounting systems that provide improved aesthetics, and more effectively facilitate connectivity of the device to the access points. Moreover, there is a need for an access point mounting system that more effectively protects connector cable from damage and contamination while enhancing space utilization at or around the access point outlet.

U.S. patent application Ser. No. 10/948,941 filed Sep. 24, 2004, discloses a work station outlet for behind the wall cable management that facilitates cable management functions, enhances space utilization at and around the work station outlet relative to the wall during cable installation and any subsequent cable additions or alterations, and allows for effective, convenient and efficient cable access as desired. The work station outlet includes a first plate suitable for being mounted or connected to the wall with at least one connector access opening and one or more guide structures. The work station also includes a second plate that operatively cooperates with the guide structures so as to slide, then pivot, relative to the first plate so as to advantageously provide a drawer feature allowing ready access to the spool and thereby enable efficient cable installation from the front side of the wall. U.S. patent application Ser. No. 10/948,941 is incorporated herein by reference in its entirety.

### SUMMARY OF THE DISCLOSURE

One aspect of the present disclosure is directed to a discrete access point mounting system that provides for efficient connectivity of multiple access points in a single system, is aesthetically pleasing, holds one or more discrete cables within a storage area, and is configured to provide for a variety of mounting arrangements. The discrete access point mounting system includes a first means for mounting a connector receptacle to a wall or other mounting surface, said first means having at least one receptacle opening and at least one wall mounting feature; a second means for mounting a connector jack, said second means having a jack opening and operatively connected to said first means via at least one interconnection means; and a third means for storing at least one connector cable, cord or line proximate said first means and said second means.

A further aspect of the present disclosure relates to a discrete access point mounting system including a surface mounting plate for mounting the system to a wall or other mounting surface, said surface mounting plate defining at least one receptacle opening and having at least one wall mounting feature; a jack mounting plate for mounting a connector jack, said jack mounting plate defining a jack opening and being connected to said surface mounting plate via at least one wall, post, pillar or column; and a cord storage area for storing a length of connector cable, cord or line proximate said mounting plate and said jack mounting plate.

Another aspect of the present disclosure relates to a method including the steps of providing a discrete access point mounting system for mounting a connector jack and at least one connector receptacle connected by at least one cable, said discrete access point mounting system having means for storing said cable to minimize damage and contamination; mounting said work station outlet to a wall or other mounting surface so as to consolidate and facilitate access point functions; and connecting one or more devices to said at least one connector receptacle to effectuate one or more communication transmission media, one or more power transmission media, or a combination of power and communication transmission medium via a streamlined and aesthetically appealing access point.

According to an aspect of the present disclosure, the surface mounting plate is formed so as to define a mounting face that includes mounting features for facilitating mounting of the surface mounting plate relative to a standard sheet rock wall or similar surface. The mounting features support the weight of the access point mounting system, and also optionally support the weight of the access point itself. Such mounting features typically take the form of slots and/or apertures, although alternative mounting features may be employed. The surface mounting plate also, as noted above, advantageously includes or defines at least one opening suitable to accommodate one or more receptacles adapted to operatively connect with one or more cable couplers.

In an alternative embodiment, the surface mounting plate is in the form of a plastic plate with contoured corners for providing improved aesthetics and functionality to the disclosed discrete access point mounting system and further including one or more connector receptacle mounting structures. Alternatively, the plastic surface mounting plate includes one or more designation fields.

In an alternative embodiment, the surface mounting plate is in the form of a metal plate with wall engaging elements for stabilizing the discrete access mounting system to a wall or other like surface.

Numerous advantages result from the discrete access point mounting system disclosed herein and the uses/applications therefore.

For example, in exemplary embodiments of the present disclosure, the discrete access point mounting system provides for the consolidation of multiple connector receptacles, connector lines, and a connector jack into a single discrete system.

In a further exemplary embodiment of the present disclosure, the disclosed discrete access point mounting system exhibits a cleaner, more aesthetic overall appearance with respect to the front of the wall or like mounting surface.

A further advantage associated with the exemplary embodiments of the disclosed discrete access point mounting system is that efficient storage of cord, cable or other line type is provided for within the system.

A further advantage associated with the exemplary embodiments of the disclosed discrete access point mounting system is that a variety of connector receptacle and connector jack types may be configured within the system.

A further advantage associated with the exemplary embodiments of the disclosed discrete access point mounting system is that, in use, the system facilitates cable protection from damage and contamination, while enhancing space utilization at and around the access point when mounted to a wall or other suitable mounting surface.

A further advantage associated with the exemplary embodiments of the disclosed discrete access point mounting system is that the system may be readily attached to and supported by a wall or other mounting surface, and may also support the weight of the access point itself.

Additional advantageous features and functions associated with the disclosed discrete access point mounting system will be readily apparent from the detailed description which follows, particularly when reviewed together with the drawings appended hereto.

### BRIEF DESCRIPTION OF THE FIGURES

To assist those of ordinary skill in the relevant art in making and using the subject matter hereof, reference is made to the appended drawings, wherein:

FIG. 1 is a perspective schematic view showing an exemplary discrete access point mounting system according to an aspect of the present disclosure.

FIG. 2 is a perspective schematic view showing an exemplary discrete access point mounting system with an alternative surface mounting plate design according to the present disclosure.

FIG. 3 is a perspective schematic view showing the discrete access point mounting system of FIG. 2 in a second illustrative position according to the present disclosure.

### DETAILED DESCRIPTION OF EXEMPLARY EMBODIMENT(S)

The present disclosure provides for an advantageous discrete access point mounting system to facilitate the connection of various devices, such as computers, telephones, fax machines, to network connections via RF technology. The discrete access point mounting system of the present disclosure may be sized, shaped and/or configured so as to accomplish any of a variety of communication transmission media connections as will be apparent to persons skilled in the art.

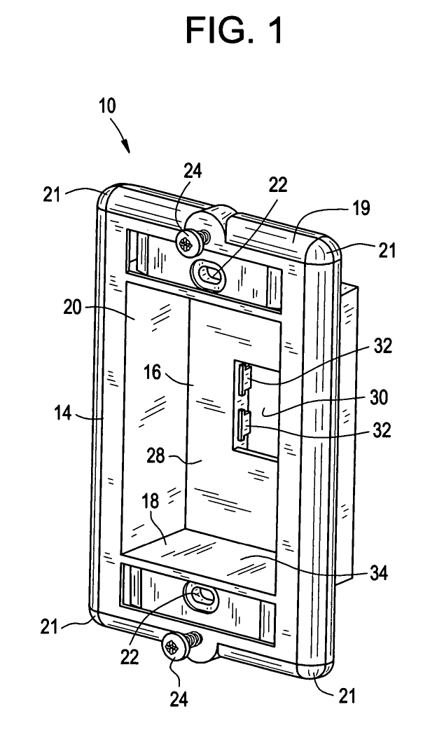

With reference to FIG. 1, an exemplary discrete access point mounting system 10 according to the present disclosure is schematically depicted. The discrete access point mounting system 10, as shown, is configured for mounting to a wall or other flat mounting surface (not shown). The discrete access point mounting system 10 includes a surface mounting plate 14 and a jack mounting plate 16 that are operatively connected to each other by at least one wall 18 affixing the surface mounting plate 14 and the jack mounting plate 16. The surface mounting plate 14 and the jack mounting plate 16 may be affixed to each other by one or more walls 18 corresponding to one to four sides of the surface mounting plate 14 and the jack mounting plate 16. Other means for affixing the surface mounting plate 14 to the jack mounting plate 16 include, but are not limited to, one or more posts, pillars, and columns.

The surface mounting plate 14 is suitable for mounting to a wall or other flat mounting surface (not shown). The surface mounting plate 14 can be fabricated from a sufficiently rigid material, e.g., a polymer or metal. As shown, the surface mounting plate 14 defines a frame 19, which in turn defines a receptacle opening 20 for facilitating receipt/mounting of one or more cable coupling modules or receptacles (not shown). The receptacle opening 20 may be configured into a variety of sizes and shapes, e.g., square, rectangular, circular, triangular, depending upon the size and shape of the coupling module or receptacle (not shown) that is to be accommodated by it. Moreover, the surface mounting plate 14 may have more than one receptacle opening 20 of the same or varying shapes and sizes to accommodate multiple cable coupling modules or receptacles (not shown) of optionally varying shapes and sizes. For example, a surface mounting plate 14 including two receptacle openings 20 with a dividing segment (not shown) between the two openings may be utilized to accommodate a data/network receptacle and an electric/power receptacle.

The frame 19 is provided with one or more cable receptacle mounting features 22, e.g., fastener holes, for mounting the discrete access point mounting system 10 to a one or more cable coupling modules or receptacles (not shown). The frame 19 is also provided with one or more wall mounting features 24, e.g., screws, posts, studs, or hooks, for mounting and supporting the weight of the discrete access point mounting system 10 to a wall or other flat mounting surface (not shown). Moreover, the one or more wall mounting features 24 may also support the weight of the access point itself It is also noted that the surface mounting plate 14 can have any of a variety of other structural features and/or configurations apparent to one skilled in the art. For example, one or more designation fields may be included on the exterior surface of the surface mounting plate 14.

As depicted in FIG. 1, the surface mounting plate 14 and frame 19 may be in the form of molded plastic to provide for rounded or contoured corners 21 such as to provide for a discrete access mounting system that is not flush with a wall or other flat mounting surface (not shown). The surface mounting plate 14 and frame 19 are not flat and have rounded or contoured corners 21, which provide for further aesthetic appeal due to streamlined and curved appearance.

The jack mounting plate 16 can be fabricated from a sufficiently rigid material, e.g., a polymer or metal. As shown, the jack mounting plate 16 also defines a frame 28, which in turn defines a jack opening or cut-out 30 for facilitating receipt/mounting of a connector jack (not shown). The jack opening 30 may be configured into a variety of sizes and shapes, e.g., square, rectangular, circular, triangular, depending upon the size and shape of the jack (not shown) that is to be accommodated by it.

As depicted in FIG. 1, the jack mounting plate 16 is parallel to the surface mounting plate 14. However, it is understood by one of skill in the art that the jack mounting plate 16 may be mounted in alternative configurations relative to the surface mounting plate 14. An exemplary alternative configuration (not shown) is to position the jack mounting plate 16 perpendicular to the surface mounting plate 14. Another exemplary alternative configuration (not shown) is to position the jack mounting plate 16 at an angle of between 0 and 90 degrees relative to the surface mounting plate 14.

As may be readily apparent to those skilled in the art, the jack mounting plate 16 can have any of a variety of other structural features suitable for facilitating effective and efficient access point functionality. For example, the frame 28 of the jack mounting plate 16 may be provided with one or more jack mounting features 32, e.g., t-style jack inputs, for holding the connector jack (not shown) in place.

Still referring to FIG. 1, the region between the surface mounting plate 14 and the jack mounting plate 16 forms a cord storage area 34 for neatly storing one or more connector cords (not shown) from one or more connector jacks (not shown) to one or more cable coupling modules or receptacles (not shown). The connector cord (not shown) may be compactly folded upon itself for placement within the cord storage area 34. The cord storage area 34 permits one or more connector cords (not shown) to be stored and protected from damage and contamination. Moreover, the connector cords (not shown) may be easily accessed from the front side of the surface mounting plate 14.

Referring now to FIG. 1, having identified and discussed various features of the discrete access point mounting system 10 according to the present disclosure, in use, the discrete access point mounting system 10 is operatively associated with a wall or other flat mounting surface (not shown) via the surface mounting plate 14, which is mounted to a wall or other flat mounting surface (not shown). The surface mounting plate 14 is substantially flush with the wall or other flat mounting surface (not shown) such as to allow the jack mounting plate 16, which is operatively associated with the surface mounting plate 14, to be recessed behind the front surface of the wall or other flat mounting surface (not shown). One or more cable coupling modules or receptacles (not shown) are positioned within the receptacle opening 20 of the surface mounting plate 14 for easy access of plug-in by a user of the device. A connector jack (not shown) is positioned within the jack opening 30 of the jack mounting plate 16 recessed behind the front surface of the wall or other flat mounting surface (not shown). The connector jack (not shown) may be held in place via the two t-style jack inputs 32. The connector jack (not shown) mounted in the jack mounting plate 16 and recessed behind the front surface of the wall or other flat mounting surface (not shown) is connected to one or more cable coupling modules or receptacles (not shown) mounted in the surface mounting plate 14 via one or more connector cords, cables or transmission lines (not shown). The one or more connector cords, cables or transmission lines (not shown) are neatly stored in the cord storage area 34 located between the surface mounting plate 14 and the jack mounting plate 16.

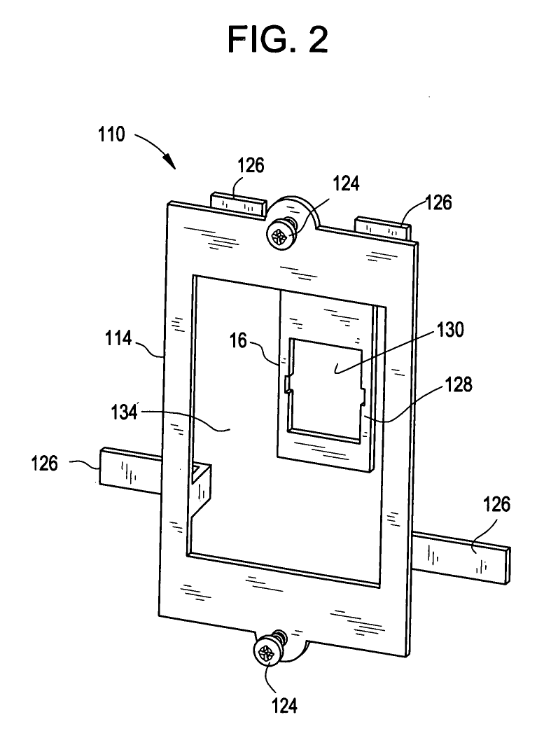

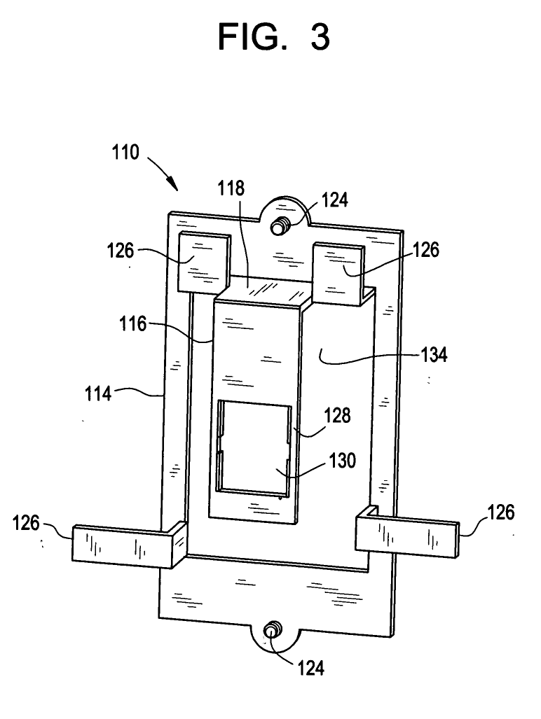

An alternative exemplary embodiment of the discrete access point mounting system 110 according to the present disclosure is schematically depicted in FIGS. 2 and 3. The discrete access point mounting system 110 is similar to the discrete access point mounting system 10 described above, and therefore like reference numerals preceded by the numeral “1” are used to indicate like elements. The discrete access point mounting system 110 is distinct from the exemplary embodiment of FIG. 1 in that the surface mounting plate is a non-contoured flat surface mounting plate fabricated from a sufficiently rigid material, e.g., a polymer or metal. The non-contoured surface mounting plate 114 is advantageously used for flush mounting to a sheet rock surface.

The discrete access point mounting system 110 is also distinct in that it includes a surface mounting plate 114 with one or more stabilizing structures 126, e.g., wall engaging elements for stabilizing the discrete access point mounting system 110. The stabilizing structures 126, in an aspect of the present disclosure, can extend through an opening formed in the wall or other flat mounting surface (not shown), and the surface mounting plate 114 secured in place by one or more wall mounting features 124, e.g., screws, posts, studs, or hooks. As depicted in FIGS. 2 and 3, the one or more wall mounting features 124 are screws which are inserted into a corresponding hole(s) (not shown) in the wall or other flat mounting surface (not shown) so as to engage the sheet rock wall or other flat mounting surface. Moreover, the one or more wall mounting features 124 may also support the weight of the access point itself.

Lastly, the discrete access point mounting system 110 of FIGS. 2 and 3 is distinct from the exemplary embodiment of FIG. 1 in that it does not have one or more cable receptacle mounting structures 22, e.g., fastener holes. However, it is understood by one skilled in the art that a combination of one or more wall engaging elements 126, and one or more cable receptacle mounting structures 22 may be provided for in an alternative embodiment.

In use, the direct access point mounting systems of the present disclosure facilitates access point functionality and in particular permitting for the consolidation of one or more connector receptacles into a single discrete system while providing for a cleaner, more aesthetic overall appearance with respect to the front of the wall or other flat mounting surface. Moreover, the direct access point mounting systems of the present disclosure also improve cable protection from damage and contamination by providing for a cord storage area for neatly storing a length of cable in a folded or alternative configuration. In addition, the direct access point mounting systems of the present disclosure may be used to accommodate a variety of different connector receptacles, cord types and jack types.

Although the discrete access mounting system of the present disclosure has been described with reference to exemplary aspects thereof, the present disclosure is not limited to such exemplary aspects. Rather, the present disclosure extends to and encompasses such modifications and/or enhancements that will be apparent to persons skilled in the art in view of the detailed description provided herein.

1. A discrete access point mounting system comprising:
(a) a first means for mounting a connector receptacle to a wall or other mounting surface, said first means having at least one receptacle opening and at least one wall mounting feature;
(b) a second means for mounting a connector jack, said second means having a jack opening and operatively connected to said first means via at least one interconnection means; and
(c) a third means for storing at least one connector cable, cord or line proximate said first means and said second means.

2. The discrete access point mounting system of claim 1, wherein said discrete access point mounting system is plastic or metal.

3. The discrete access point mounting system of claim 2, wherein said first means is a surface mounting plate defining a frame.

4. The discrete access point mounting system of claim 3, wherein said surface mounting plate further comprises at least one wall engaging element.

5. The discrete access point mounting system of claim 3, wherein said surface mounting plate further comprises at least one designation field.

6. The discrete access point mounting system of claim 3, wherein said plastic surface mounting plate surface has non-flat contoured corners.

7. The discrete access point mounting system of claim 6 further comprising at least one receptacle mounting feature.

8. The discrete access point mounting system of claim 7, wherein said receptacle mounting feature is a fastener hole.

9. The discrete access point mounting system of claim 1, wherein said at least one wall mounting feature is selected from the group consisting of screws, posts, studs and hooks.

10. The discrete access point mounting system of claim 1, wherein said at least one wall mounting feature supports the weight of said discrete access point mounting system, the weight of an access point, or a combination thereof.

11. The discrete access point mounting system of claim 1, wherein said at least one receptacle opening is rectangular, square, circular, or triangular in shape.

12. The discrete access point mounting system of claim 2, wherein said second means is a jack mounting plate defining a frame.

13. The discrete access point mounting system of claim 12, wherein said jack mounting plate further comprises at least one jack mounting feature.

14. The discrete access point mounting system of claim 1, wherein said at least one interconnection means is selected from the group consisting of walls, posts, pillars and columns.

15. The discrete access point mounting system of claim 1, wherein said third means is a cord storage area formed between said connector jack and said connector receptacle.

16. The discrete access point mounting system of claim 1, wherein said first means and said second means are connected via said interconnection means at angle of between about 0 degrees and about 90 degrees.

17. A discrete access point mounting system comprising:
(a) a surface mounting plate for mounting the system to a wall or other mounting surface, said surface mounting plate defining at least one receptacle opening and having at least one wall mounting feature;
(b) a jack mounting plate for mounting a connector jack, said jack mounting plate defining a jack opening and being connected to said surface mounting plate via at least one wall, post, pillar or column; and
(c) a cord storage area for storing a length of connector cable, cord or line between said surface mounting plate and said jack mounting plate.

18. The discrete access point mounting system of claim 17, wherein said discrete access point mounting system is plastic or metal.

19. The discrete access point mounting system of claim 18, wherein said plastic discrete access point mounting system further comprises a surface mounting plate having non-flat contoured corners for an aesthetically appealing access point, at least one receptacle mounting feature, and at least one jack mounting feature.

20. The discrete access point mounting system of claim 18, wherein said surface mounting plate further comprises at least one wall engaging element.

21. The discrete access point mounting system of claim 17, wherein said at least one wall mounting feature supports the weight of said discrete access point mounting system, the weight of an access point, or a combination thereof.

22. A method comprising:
providing a discrete access point mounting system for mounting a connector jack and at least one connector receptacle connected by at least one cable, said discrete access point mounting system having means for storing said cable to minimize damage and contamination;
mounting said discrete access point mounting system to a wall or other mounting surface so as to consolidate and facilitate access point functions; and
connecting one or more devices to said at least one connector receptacle to effectuate one or more communication transmission media, one or more power transmission media, or a combination of power and communication transmission medium via a streamlined and aesthetically appealing access point.

23. An access point mounting apparatus, comprising:
(a) a jack mounting plate;
(b) at least one element outwardly extending from said jack mounting plate; and
(c) at least two spaced mounting members extending outwardly relative to the jack mounting plate;
wherein the jack mounting plate defines an opening for passage of transmission media;
wherein the at least two spaced mounting members are configured to cooperate with corresponding structures on an access point for mounting the access point relative to the jack mounting plate; and
wherein the jack mounting plate and the at least one outwardly extending element define a storage region for receipt of cordage associated with the mounted access point.

24. An access point mounting apparatus according to claim 23, wherein the at least one outwardly extending element is selected from the group consisting of a wall, a post, a pillar, and a column.

25. An access point mounting apparatus according to claim 23, wherein the at least one outwardly extending element includes a plurality of walls.

26. An access point mounting apparatus according to claim 23, further comprising a surface mounting plate outwardly spaced from the jack mounting plate and mounted with respect to the at least one outwardly extending element.

27. An access point mounting apparatus according to claim 26, wherein the at least two spaced mounting members are mounted with respect to the surface mounting plate.

28. An access point mounting apparatus according to claim 26, further comprising at least one stabilizing structure extending from the surface mounting plate, wherein the at least one stabilizing structure is configured to engage a wall surface.

29. An access point mounting apparatus according to claim 23, wherein the at least two spaced mounting members are selected from the group consisting of screws, posts, studs and hooks.

30. An access point mounting apparatus according to claim 23, further comprising a connector jack mounted with respect to the opening in the jack mounting plate.
